(19) United States
(12) Patent Application Publication
(10) Pub. No.: US 2020/0120877 A1
(43) Pub. Date: Apr. 23, 2020

(54) PLANT ILLUMINATION CHAMBER

(71) Applicant: COMPLED SOLUTIONS GMBH, Dresden (DE)

(72) Inventors: Christoph SCHUBERT, Dresden (DE); Arne LEHMANN, Dresden (DE)

(73) Assignee: COMPLED SOLUTIONS GMBH, Dresden (DE)

(21) Appl. No.: 16/617,653

(22) PCT Filed: Jun. 11, 2018
(86) PCT No.: PCT/DE2018/000185

§ 371 Date: Nov. 27, 2019

(30) Foreign Application Priority Data
Jun. 14, 2017 (DE) 20 2017 003 167.1

(51) Int. Cl. A01G 7/04; F21V 21/22

(52) U.S. Cl. CPC A01G 7/045; F21V 21/22

(57) ABSTRACT

The invention relates to a plant illumination chamber, comprising at least one internal surface configured with reflective material on its internal side and one illuminating device, wherein the illuminating device consists of a base unit and at least two light sources. The purpose of the invention is to create a plant illumination chamber, wherein a broad variation of the radiation characteristic of the illuminating device in the plant illumination chamber is possible with little expenditure on work and materials. Furthermore, the illuminating device should also be universally suitable for use in plant illumination chambers of different sizes. This object is achieved in that each of these light sources is movable on one supporting element of the base unit of the illuminating device and can be fixed with a locking device in a position of use, and in that the light sources can be moved relative to the internal surface and/or in relation to one another.

### CROSS-REFERENCE TO RELATED APPLICATIONS

This application is a 371 U.S. National Stage of International Application No. PCT/DE2018/000185, filed on Jun. 11, 2018, which claims the benefit of German Patent Application No. 20 2017 003 167.1, filed Jun. 14, 2017. The entire disclosures of the above applications are incorporated herein by reference.

### FIELD

The invention relates to a plant illumination chamber, comprising at least one internal surface configured with reflective material on its internal side and one illuminating device, wherein the illuminating device consists of a base unit and at least two light sources.

### BACKGROUND

This section provides background information related to the present disclosure which is not necessarily prior art.

In research with plants, the plants under laboratory conditions are typically grown in plant-illumination cabinets or walk-in plant illumination chambers. Other common designations of such cabinets or chambers are grow cabinets/chambers, plant-growth cabinets/chambers, climate cabinets/chambers and phyto-cabinets/-chambers. In the following, the term ‘plant illumination chamber’ stands for all the above terms. Plant illumination chambers are mostly enclosed rooms that are accessible through a door. In addition to air-conditioning, ventilation and watering equipment, an illuminating device is also installed in this space to irradiate the plants accommodated in the plant illumination chamber with light.

According to the state of the art, various solutions for illumination systems for plant illumination chambers are known.

EP 3 138 386 A1 describes an illuminating device arranged in the plant illumination chamber in a fixed position above a drawer that accommodates the plants. Here, the radiation characteristics of the illuminating device are defined by the individual light sources, their mutually relative positions and their positions relative to the internal wall of the plant illumination chamber. The disadvantage of this solution is that the radiation characteristics are dictated by the fixed position of the illuminating device. This can be varied only by replacing the illuminating device with one where the light sources are arranged in a different manner.

DE 20 2010 001 366 U1 describes an illuminating device for a plant illumination chamber, wherein this illuminating device features translucent components on the light sources. These translucent components are configured as elements to modify the propagation of light and to guide the beams of light emitted by the light sources. The radiation characteristic of the illuminating device can be varied by changing the properties of the elements modifying the light propagation. These properties can be changed, for example, by inclusions of gases, liquids or solid particles. Furthermore, indentations in the elements or surface coatings on the elements can modify the propagation of light. Nevertheless, this process is costly, as the components for varying the radiation characteristics generally have to be replaced, which results in an increase in expenditure of time and materials. In addition, this type of device reduces the efficiency of the illumination system sometimes considerably.

WO 2013/160534 A1 describes an illuminating device with a light-source carrier, to which two light sources are fastened such that they can be rotated. The two light sources can be pivoted with respect to one another, so that the directions of emission of the light sources can be changed independently of one another. This makes it possible to adapt the radiation characteristics of the overall system.

U.S. Pat. No. 6,688,759 B1 discloses a star-shaped illuminating device, wherein the star shape is completely covered with LEDs. The star tips are mounted on pivots so that the position can be varied for the LEDs arranged on the star tips.

As the light sources of the two last-mentioned solutions can be only pivoted or tilted relative to one another, the radiation characteristics of the illuminating device can be varied only to a limited extent.

### SUMMARY

This section provides a general summary of the disclosure, and is not a comprehensive disclosure of its full scope or all of its features.

The purpose of the invention is to create a plant illumination chamber, wherein a broad variation of the radiation characteristic of the illuminating device in the plant illumination chamber is possible with little expenditure on work and materials. Furthermore, the illuminating device should also be universally suitable for use in plant illumination chambers of different sizes.

This object is achieved in that at least two light sources of the illuminating device, each on one supporting element of a base unit, can be moved and fixed in a usage position by a locking device, and that the light sources can be moved relative to an internal surface of the plant illumination chamber and/or relative to one another.

It is proposed that the internal surface have a lower area and an upper area, and that both areas differ in respect of their optically reflective properties.

In one embodiment, the lower area is diffusely reflecting and the upper area is configured as a specular reflector. A specularly reflecting surface is characterised by mainly directed reflection at the surface. Diffuse scattering or diffuse reflection occurs, for example, on rough surfaces. The specular reflection in the upper area directs the light to the target with the lowest possible scattering losses, which increases the intensity at the target height of the plants and thus increases efficiency. With the diffuse reflection in the lower area of the plant illumination chamber, the light from the light sources of the illuminating device is scattered on the internal surface and thus increases the all-round effective amount of light on the plants deposited in the plant illumination chamber, and particularly in the leaf area of the plants.

One embodiment provides that the lower area and/or the upper area of the internal surfaces of the plant illumination chamber be each provided with a wall cladding, and that said wall cladding have different optically reflective properties relative to the reflective material. Depending on the application, the optically reflective properties of the two areas of the internal surface can thus be varied by attaching appropriate wall claddings.

One embodiment provides that, with known optical characteristics of the reflective material and/or the wall cladding, a radiation characteristic of the illuminating device in the plant illumination chamber can be adjusted by changing the positions of the light sources relative to one another.

A further embodiment provides that, with known optical characteristics of the reflective material and/or the wall cladding, a radiation characteristic of the illuminating device in the plant-illumination cabinet be adjusted by changing the positions of the light sources relative to the internal surface.

The radiation characteristics in the plant illumination chamber result from the interaction of the optical properties of the internal surfaces of the plant illumination chamber and the positions of the light sources within the plant illumination chamber. If the optical properties of the internal surfaces are known, or provided by the application of a defined reflective material, it is possible to adjust a defined radiation characteristic via the positions of the light sources in relation to one another and/or in relation to the internal surface of the plant illumination chamber. Thus, a radiation characteristic of the entire arrangement can be attributed to each positioning of the light sources. With the illuminating device according to the invention, the mutually relative positions of the light sources can be modified by simply repositioning the light sources on the supporting elements. In this way, the characteristic of illumination can be varied in the plant illumination chamber and adapted to each particular application. Advantageously, no replacement of light sources or use of beam-changing elements is required, which means that little work is required and no additional material is required. Furthermore, it is thus possible to keep the efficiency of the overall system at the highest possible level, since the loss of efficiency due to radiation-modifying elements is avoided. In addition, due to the adjustability of the light source positions, the illuminating device can be used for plant illumination chambers of different sizes. By applying further wall cladding to the internal surfaces, at least in sections, the radiation characteristics can be further optimised in interaction with the positions of the light sources.

It is proposed that the wall cladding be fixed to the internal surface magnetically, or with a clamping element, or with a screwed element, or via an adhesive connection.

In one embodiment, the light sources can be moved in a plane parallel to the surface on which the plant illumination chamber is stood.

One embodiment provides for the light sources to be fixable in continuously variable positions.

In another embodiment, the light sources can be fixed at discrete positions of use.

The supporting elements are proposed to be telescopic rods.

One embodiment provides for the locking device to have a locking pin that can be inserted into two axially aligned openings in two rod elements of the telescopic rods.

A further embodiment provides that the locking device have a knurled screw, and that this knurled screw can be screwed into the wall of a first rod element of the telescopic rods, and that one end of the knurled screw, facing the internal surface of the first rod element, rests on the external surface of a second rod element, which is at least partially arranged within the first rod element of the telescopic rods.

One embodiment provides that the supporting elements be equipped with a track system having a slide that can traverse the same, and that the respective light source be fastened to this slide.

A further embodiment provides that the locking device have a knurled screw, and that this knurled screw can be screwed into a wall of the slide and that one end of the knurled screw facing the track system rests on an outer side of the track system.

Furthermore, it is proposed that the light sources be light-emitting diodes.

In one embodiment, the illuminating device is configured with a hanging device.

It is proposed that at least one internal surface of the plant illumination chamber be configured with a reflective material, and the light sources can be moved relative to this internal surface.

In one embodiment, all internal surfaces of the plant illumination chamber are equipped with a reflective material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

One embodiment of the invention is explained by means of the drawings below.

These show:

FIG. 1 An external view of an embodiment of a plant illumination chamber according to the invention

FIG. 2a An internal view of the plant illumination chamber according to FIG. 1

FIG. 2b A further internal view of the embodiment of the plant illumination chamber according to FIG. 2a

FIG. 2c An internal view of a further embodiment of the plant illumination chamber

FIG. 2d A frontal view of the embodiment according to FIG. 2c

FIG. 3 A top view of the illuminating device according to FIG. 2 with retracted supporting elements

FIG. 4 A side view of the illuminating device according to FIG. 3

FIG. 5 A further top view of the illuminating device with extended supporting elements

FIG. 6 A side view of the illuminating device according to FIG. 5

### DETAILED DESCRIPTION

Example embodiments will now be described more fully with reference to the accompanying drawings.

FIG. 1 shows an external view of an embodiment of a plant illumination chamber 1 according to the invention. The plant illumination chamber 1 is configured as an enclosed space with side panels 2, which is accessible through a door. The side panels 2 of the plant illumination chamber 1 are configured to be opaque. The illustration shows only two of the four side panels 2.

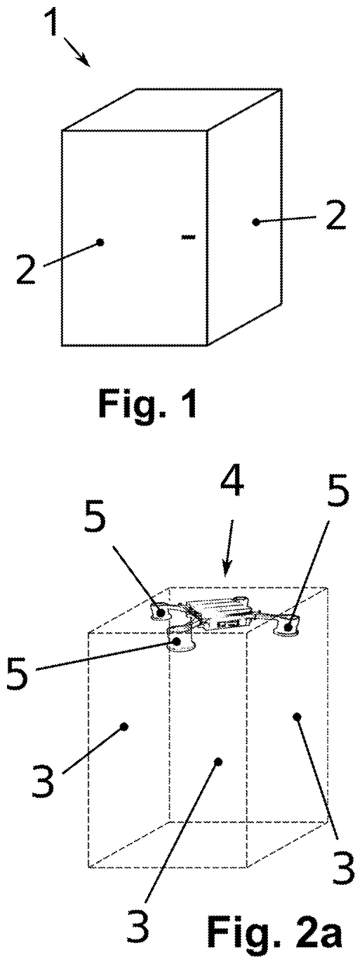

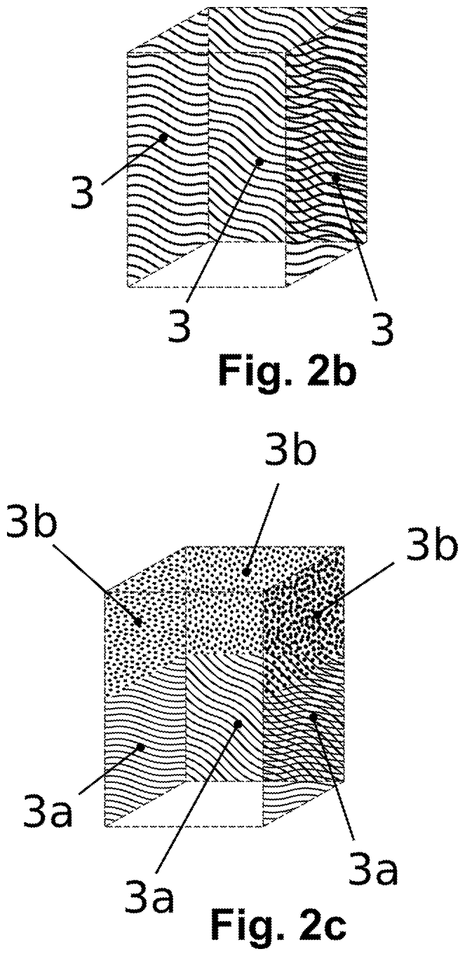

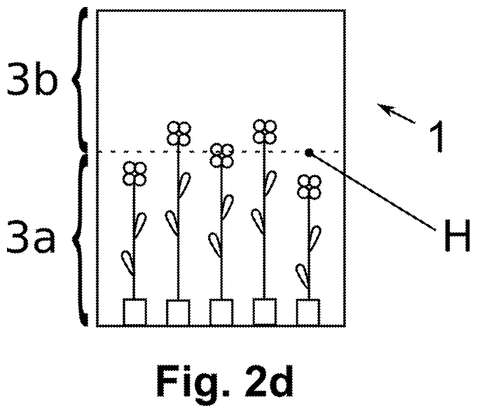

FIG. 2a shows an interior view of the plant illumination chamber 1 according to FIG. 1. On the upper internal surface of the plant illumination chamber 1, an illuminating device 4 with light sources 5 is attached.

FIG. 2b shows a further interior view of the embodiment of the plant illumination chamber 1 according to FIG. 2a. The side panels 2 have internal surfaces 3 facing into the plant illumination chamber 1. These internal surfaces 3 are designed with a specularly or diffusely reflecting surface. For reasons of clarity, the illuminating device 4 is not shown. The internal surface 3 of side panel 2, which is configured as a door but is not visible, is configured in accordance with the other internal surfaces 3 visible in the illustration.

FIG. 2c is an interior view of a further embodiment of the plant illumination chamber 1. The internal surfaces 3 of the plant illumination chamber 1 are configured in two parts, wherein a lower area 3a of the internal surfaces 3 is configured to be diffusely reflecting and an upper area 3b of the internal surfaces 3 is a specular reflector. As already described in FIG. 2b, the internal surface 3 of the side panel 2, which is configured as a door but is not visible, is configured in accordance with the other internal surfaces 3 visible in the illustration. The various reflective properties can be achieved, for example, by fixing a corresponding wall cladding to the internal surface 3, starting from the embodiment according to FIG. 2b in the upper area 3b and thus changing the optical properties of this area 3b of the internal surface 3. In principle, however, only the lower area 3a can be provided with a wall cladding, so that the optically reflective properties of the two areas differ from one another. Likewise, both the lower area 3a and the upper area 3b can each be provided with a wall cladding, wherein these two wall claddings then differ in terms of their optically reflective properties, and thus the corresponding specular or diffuse reflection is achieved.

The internal surfaces 3 are ideally designed so that the wall claddings can be attached to these internal surfaces 3 in a simple manner and can be replaced with little effort. In an example, the wall claddings are magnetically attached to the internal surfaces. The wall claddings can also be attached, for example, with clamping, screwed or adhesive elements.

With knowledge of the optical properties of internal surfaces 3, 3a, 3b or of the wall cladding, a defined radiation characteristic within the plant illumination chamber 1 can be set via the positioning of the light sources 5. The radiation characteristic can be determined in advance, for example, empirically or via a computer simulation. The optical properties are known to the manufacturer or can be determined by means of measurements.

FIG. 2d shows a frontal view of the embodiment according to FIG. 2c. The size of the upper areas 3b and the lower areas 3a of the internal surfaces 3 can be adapted to the respective group of plants to be illuminated, depending on the application. For example, a height of the lower area 3a extends from the bottom of the plant illumination chamber 1 to a desired mean plant height H of the plants set up in the plant illumination chamber 1. The upper area then extends from this mean plant height H to the top end of the plant illumination chamber 1. The extension of the lower and upper areas 3a, 3b is not limited to this embodiment. Thus, the height of the lower area 3a is not tied to the mean plant height, but can also be defined by other parameters. Thus, in principle, other divisions are conceivable, depending on the application. Likewise, the internal surfaces may also be subdivided into more than two areas with varying optically reflective properties.

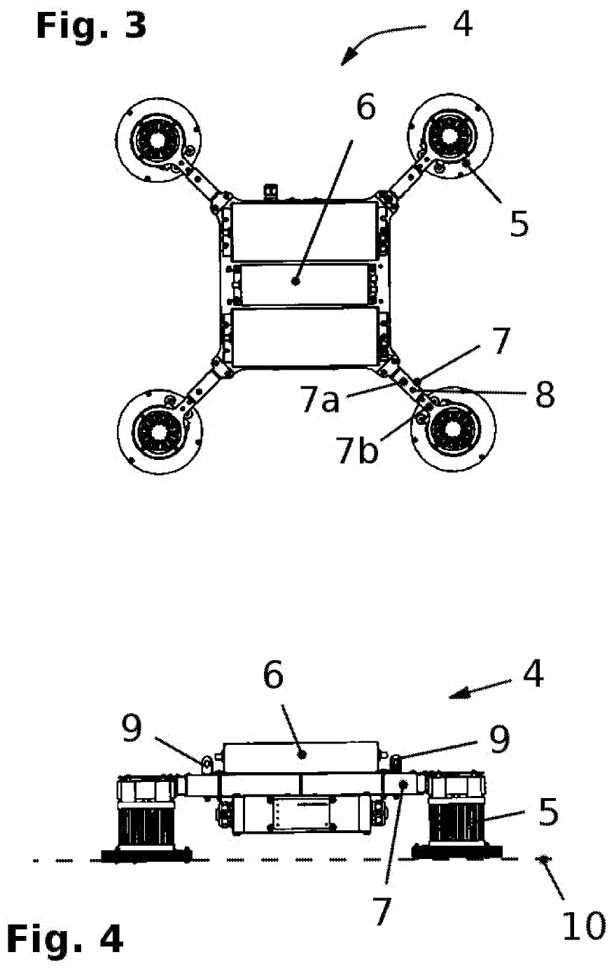

FIG. 3 shows a top view of the illuminating device 4 of the plant illumination chamber 1 according to FIG. 1. The plant illumination chamber 1 is not shown. The illuminating device 4 has a base unit 6, four supporting elements 7 and four light sources 5. The light sources 5 are equipped with light-emitting diodes, wherein the illuminating device 4 according to the invention is not limited thereto. For example, sodium-vapour lamps can also be used. The light sources 5 are each attached to one of the supporting elements 7. The supporting elements 7 are configured as telescopic rods, wherein each telescopic rod has a first rod element 7a and a second rod element 7b disposed at least partially within the first rod element 7a. The light sources 5 are attached to the second rod element 7b. By pushing the second rod element 7b into the first rod element 7a, the respective light source 5 is moved along the supporting element 7. In a desired position of use, the two rod elements 7a, 7b of the holding element 7 are then fixed relative to one another with a locking device 8. Depending on the configuration of the locking device 8, continuously variable fixing mounting or fixing in discrete positions is possible. In the illustrated variant, the second rod element 7b is almost completely inserted into the first rod element 7a.

FIG. 4 shows a side view of the illuminating device 4 according to FIG. 3. A hanging device 9 of the illuminating device 4 is depicted in addition to the main body 6, the supporting elements 7 and the light sources 5. This hanging device 9 consists of eyelets, which are attached to the base unit 6 of the illuminating device 4. The illuminating device 4 can be suspended in the plant illumination chamber 1 by means of this hanging device 9, wherein the latter device is usually mounted on a ceiling element on an internal surface of the plant illumination chamber 1. As an advantage, the light sources 5 can be moved in a light-source plane 10 parallel to a surface on which the plant illumination chamber 1 is stood. In the illustration, the beam direction of the light sources 5 points downwards.

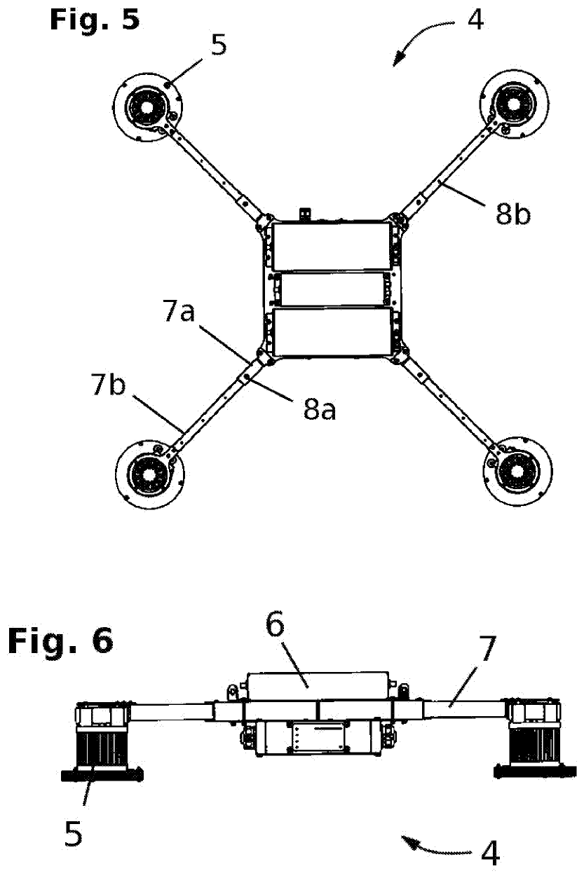

FIG. 5 shows a further top view of the illuminating device 4 in accordance with the invention with extended supporting elements 7. The second rod element 7b is almost completely pulled out of the first rod element 7a and fixed with locking device 8. The locking device 8 has a locking pin 8a, which can be inserted into two mutually aligned apertures 8b of the rod elements 7a, 7b. Both rod elements 7a, 7b are configured with several openings 8b to allow for their fixing in discrete positions for use. However, the locking device 8 is not limited to this. For example, it can also have a knurled screw, which can be screwed into a wall of the first rod element 7a, wherein an end of the knurled screw facing the internal surface of the rod element 7a rests against an external surface of the second rod element 7b. Likewise, the locking device 8, for example, can be implemented solely by the frictional forces generated between the two rod elements 7a, 7b ; in the two last-mentioned variants, continuously variable fixing is possible.

FIG. 6 shows a side view of the illuminating device 4 according to FIG. 5.

The illuminating device 4 according to the invention is not limited to four light sources 5 and four supporting elements 7. The illuminating device 4 should generally have at least two light sources 5. Furthermore, the illuminating device 4 is not limited to supporting elements configured as telescopic rods 7. For example, the supporting elements 7 can also consist of a track system with a movable slide running on it, wherein the respective light source 5 is attached to that slide. In this case, the locking device 8 has a knurled screw, characterised in that the latter can be screwed into a wall of the slide and wherein an end of this knurled screw facing the track system rests on an external surface of the track system.

The foregoing description of the embodiment has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-17. (canceled)

18. A plant illumination chamber, including at least one internal surface comprising a reflective material, and an illuminating device,
wherein the illuminating device has a base unit and at least two light sources,
wherein each of these light sources is movable on one supporting element of the base unit and capable of being fixed in a position of use by means of a locking device, and
wherein the light sources are capable of being moved in relation to the internal surface and/or in relation to one another, and
wherein a radiation characteristic of the illuminating device in the plant illumination chamber can be adjusted in view of the known optical properties of the reflective material via a positioning of the light sources relative to one another and a positioning of the light sources in relation to the internal surface.

19. The plant illumination chamber according to claim 18, wherein the internal surface has a lower area and an upper area, and that both areas differ in regard to their optically reflective properties.

20. The plant illumination chamber according to claim 19, wherein the lower area is diffusely reflective, while the upper area is configured as a specular reflector.

21. The plant illumination chamber according to claim 18, wherein the lower area and/or the upper area of the internal surfaces of the plant illumination chamber are each provided with a wall cladding, and that this wall cladding has optically reflective properties different to those of the reflective material.

22. The plant illumination chamber according to claim 21, wherein the wall cladding is fixed to the internal surface magnetically, or with a clamping element, or with a screw element, or via an adhesive connection.

23. The plant illumination chamber according to claim 21, wherein, with known optical properties of the wall cladding, the radiation characteristic of the illuminating device in the plant illumination chamber can be adjusted via a mutually relative positioning of the light sources and a positioning of the light sources relative to the internal surface.

24. The plant illumination chamber according to claim 18, wherein the light sources can be moved within a light-source plane that is parallel to the surface on which the plant illumination chamber is stood.

25. The plant illumination chamber according to claim 18, wherein the light sources are fixable in continuously variable positions.

26. The plant illumination chamber according to claim 18, wherein the light sources are fixable in discrete positions of use.

27. The plant illumination chamber according to claim 18, wherein the supporting elements are telescopic rods.

28. The plant illumination chamber according to claim 27, wherein the locking device has a locking pin, which can be inserted into two axially aligned openings of two rod elements of the telescopic rods.

29. The plant illumination chamber according to claim 18, wherein the supporting elements are equipped with a track system and a slide attached to it, which can be moved on it, and that the respective light source is attached to that slide.

30. The plant illumination chamber according to claim 26, wherein the locking device is equipped with knurled screw, and in that this knurled screw can be screwed into one wall of the slide, and one end of this knurled screw facing the track system rests on an external surface of the track system.

31. The plant illumination chamber according to claim 26, wherein the locking device has a knurled screw and that this knurled screw can be twisted into a wall cladding of a first rod element of the telescopic rods, and in that one end of the knurled screw, facing an internal surface of the first rod element, rests on the second rod element disposed at least partially within the first rod element of the telescopic rods.

32. The plant illumination chamber according to claim 18, wherein the light sources are light-emitting diodes.

33. The plant illumination chamber according to claim 18, wherein the illuminating device has a hanging device.

34. An illuminating device for a plant illumination chamber, the illuminating device comprising:
a base unit;
a plurality of supporting elements;
a plurality of light sources; and
a locking device;
wherein each of the plurality of supporting elements comprises a proximal end portion and a distal end portion, wherein the distal end portion is telescopingly engaged with the proximal end portion;
wherein the proximal end portion is attached to the base unit and the distal end portion is extensible from the proximal end portion along a longitudinal axis such that the supporting element can comprise a plurality of different overall lengths;
wherein the locking device is configured to affix the proximal end portion member to the distal end portion at any of the plurality of different overall lengths of the supporting element;
wherein each of the plurality of light sources is attached to a respective distal end portion of a respective supporting element; and
wherein the overall length of each of the plurality of supporting elements is independently configurable from the others of the plurality of supporting elements such that each of the plurality of light sources is positionable relative to the others of the plurality of light sources and to the base unit.

35. A plant illumination chamber comprising the illuminating device of claim 34 and further comprising:
an enclosed space defined by a plurality of side panels, each side panel comprising an interior surface facing the enclosed space;
wherein the interior surface of at least one of the plurality of side panels comprises a lower area configured to be diffusely reflecting and an upper area configured as a specular reflector comprising known optical properties;
wherein the illuminating device is disposed at an upper end of the enclosed space; and
wherein a radiation characteristic within the enclosed space can be adjusted by positioning the light sources relative to one another and in relation to the interior surface of the at least one of the plurality of side panels.

36. An illuminating device for a plant illumination chamber, the illuminating device comprising:
a base unit;
a plurality of supporting elements;
a plurality of light sources; and
a locking device;
wherein each of the plurality of supporting elements comprises a track having a proximal end, a distal end, and a slide member movable along the track from the proximal end to the distal end, the proximal end being attached to the base unit;
wherein each of the plurality of light sources is attached to a respective slide member of a respective supporting element and is positionable along a respective track from the respective proximal end to the respective distal end; and
wherein the locking device is configured to affix the slide member to the track at any of a plurality of different positions along the track;
wherein each of the plurality of light sources is independently positionable relative to the base unit and the others of the plurality of light sources.

37. A plant illumination chamber comprising the illuminating device of claim 36 and further comprising:
an enclosed space defined by a plurality of side panels, each side panel comprising an interior surface facing the enclosed space;
wherein the interior surface of at least one of the plurality of side panels comprises a lower area configured to be diffusely reflecting and an upper area configured as a specular reflector comprising known optical properties;
wherein the illuminating device is disposed at an upper end of the enclosed space; and
wherein a radiation characteristic within the enclosed space can be adjusted by positioning the light sources relative to one another and in relation to the interior surface of the at least one of the plurality of side panels.
